(19) United States
(12) Patent Application Publication
(10) Pub. No.: US 2011/0258380 A1
(43) Pub. Date: Oct. 20, 2011

(54) FAULT TOLERANT STORAGE CONSERVING MEMORY WRITES TO HOST WRITES

(75) Inventors: Ryan James Goss, Lakeville, MN (US); Kevin Gomez, Eden Prairie, MN (US); Mark Allen Gaertner, Vadnais Heights, MN (US); Bruce Douglas Buch, Westborough, MA (US)

(73) Assignee: SEAGATE TECHNOLOGY LLC, Scotts Valley, CA (US)

(21) Appl. No.: 12/763,003

(22) Filed: Apr. 19, 2010

(51) Int. Cl. G06F 12/16

(52) U.S. Cl. 711/114; 711/E12.103

(57) ABSTRACT

A data storage apparatus and associated method involving a memory with a plurality of storage elements defining an associated set of stored data, and memory control logic that, responsive to a request to store first data in a first storage element of the plurality of storage elements, computes without storing to any of the plurality of storage elements first redundancy data for the associated set of stored data inclusive of the first data.

### SUMMARY

In some embodiments a data storage is provided having a memory with a plurality of storage elements defining an associated set of stored data, and memory control logic that, responsive to a request to store first data in a first storage element of the plurality of storage elements, computes without storing to any of the plurality of storage elements first redundancy data for the associated set of stored data inclusive of the first data.

In some embodiments a method is provided including steps of receiving a host command by a data storage device corresponding to storing data in a first storage element of a memory having a plurality of storage elements defining an associated set of stored data, and in response to the receiving step, computing without storing to any of the plurality of storage elements first redundancy data for the associated set of stored data inclusive of the first data.

In some embodiments a data storage apparatus is providing having a solid state memory (SSM) that stores a first data via a first channel to be part of an associated set of stored data, and writeback logic appending to the first channel, without storing to the SSM, first updated data corresponding to an update of the first data, and appending to a different channel, without storing to the SSM, first redundancy data for the associated set of stored data inclusive of the first updated data.

### BRIEF DESCRIPTION OF THE DRAWINGS

FIG. 1 is a functional block depiction of a data storage device constructed in accordance with embodiments of this invention and in a data transfer relationship with a host.

FIG. 2 is a functional block diagram of a portion of the memory in the data storage device of FIG. 1.

FIG. 3 is a tabular depiction of the memory in the data storage device of FIG. 1 mapped across sixteen communication channels in a fault tolerant arrangement.

FIG. 4 is a subset of the tabular depiction of FIG. 3 aligned with buffer indices for appending updated data from host writes before flushing the data to memory.

FIG. 5 is similar to FIG. 4 showing update data 1′ and corresponding redundancy data P(1′) appended to channel 0 and channel 15, respectively.

FIG. 6 is similar to FIG. 5 but further showing update data 5′ and corresponding redundancy data P(1′+5′) appended to channel 1 and channel 15, respectively.

FIG. 7 is similar to FIG. 6 but further showing update data 3′ and corresponding redundancy data P(1′+5′+3′) appended to channel 14 and channel 15, respectively.

FIG. 8 is a flowchart depicting steps in a method of FAULT TOLERANT WRITING performed by the data storage device of FIG. 1 executing programming instructions stored in memory in accordance with embodiments of the present invention.

### DESCRIPTION

Some types of data storage devices utilize a semiconductor array of solid-state memory cells to store data. The memory cells can be volatile or non-volatile. These solid-state devices (“SSDs”) are preferably formatted to store the computational data that is directly useful to the user, or “user data,” in a fault tolerant manner such that the user data can be recovered in the event of a storage error. As such, the SSD also stores ancillary data, or “redundancy data,” that is only needed when recovering user data from a storage error. The redundancy data can be mirrored data, parity data, executable error correction code, and the like.

Accordingly, when a host access command causes previously stored user data in the SSD to be updated, then generally both the user data and the corresponding redundancy data must be re-written to reflect the update. That requires at least a 2-to-1 ratio of SSD writes (or “memory writes”) to host writes. Such a 2:1 ratio is inconsequential in other types of storage devices, such as magnetic media storage, which can be written to repeatedly with practically no limit to the number of writes. However, the useful life of an SSD memory is inversely proportional to the number of writes it has performed. As such, the present embodiments are advantageously constructed and operated to provide a ratio of memory writes to host writes well below the nominal 2:1 ratio to extend the useful life and reliability of the SSD.

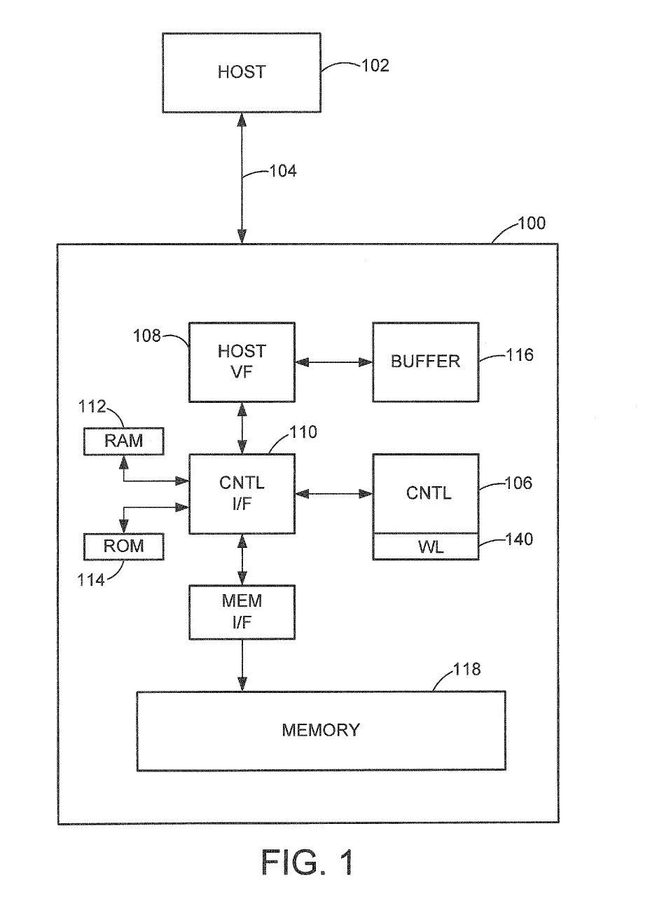

FIG. 1 is a functional block depiction of an SSD 100 that is constructed and operated in accordance with embodiments of the present invention. The SSD 100 is responsive to access commands from a host 102 via a communication link 104, such as but not limited to a network. Top level control of the SSD 100 is carried out by a suitable controller 106, which can be programmable or a hardware-based microcontroller. The controller 106 communicates with the host 102 via a host interface circuit 108 and a controller interface circuit 110.

The SSD 100 can self-execute routines without input from the host 102 or any other device via the communication link 104 by accessing corresponding programming instructions, data, rules and the like from a random access memory (RAM) 112 and read-only memory (ROM) 114. A buffer 116 can temporarily store input write data from the host 102 pending transfer to a memory 118, and can likewise temporarily store output read data from the memory 118 pending transfer to the host 102. The buffer 116 can also suitably serialize or deserialize the access commands and data to maximize the throughput performance of the SSD by parallel processing multiple access commands to different communication channels in the memory 118. Although the buffer 116 is diagrammatically depicted in FIG. 1 as a discrete circuit, such depiction is entirely illustrative and in alternative equivalent embodiments the buffer 116 can reside within any of the other circuits.

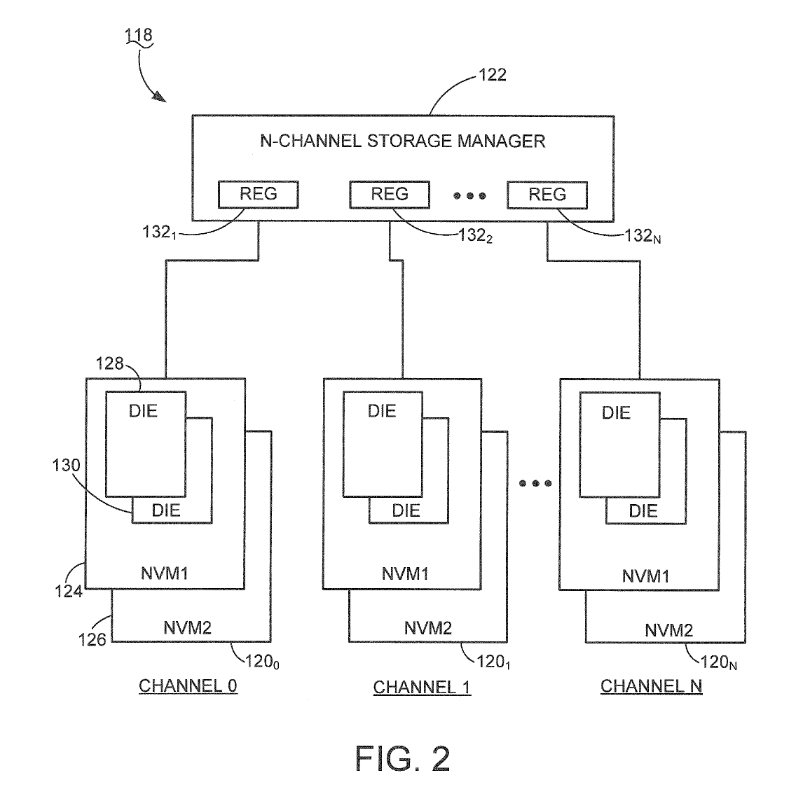

FIG. 2 is a functional block depiction of portions of the memory 118 forming the multiple communication channels 120₀, 120₁, . . . 120_{N}. A multi-channel non-volatile memory (“NVM”) controller 122 can reside in a storage switch for routing data to and from the various channels 120. Each channel 120 in these illustrative embodiments preferably has multiple flash-memory packages, such as the depicted pair of packages 124, 126. Each package 124, 126 preferably contains multiple dies, such as the depicted first die 128 and second die 130, and each die 128, 130 preferably has multiple planes per die. Registers 132 are used to buffer data destined to each of the channels 120.

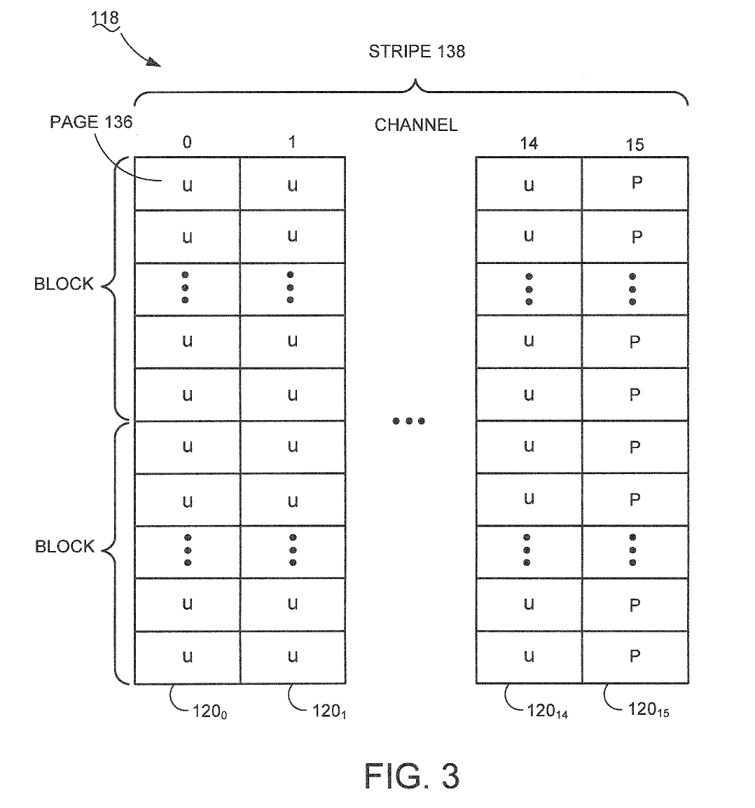

FIG. 3 and similar FIGS. thereafter are used to illustrate embodiments of the present invention in which a plurality of pages 136 of storage capacity are physically allocated to form stripes 138, or “page stripes,” across sixteen channels of the multiple channel solid state memory 118. User data is stored in pages denoted by “u,” and redundancy data for fault tolerance is stored in the pages denoted by “p” for parity data in these illustrative embodiments. Note that in these illustrative embodiments the channel 15 is dedicated to storing parity data, in a manner suitable for allocating the storage space for a RAID 5 fault-tolerant arrangement. In alternative equivalent embodiments, not shown, the parity data pages of different page stripes can be uniformly distributed among all the channels to optimize the memory 118 utilization during read operations.

The page stripes are thus physically fixed to the memory elements but dynamically logically mapped. That is, there is no fixed physical location of a logical block to any particular physical page stripe. Updated user data is accumulated to build a new page stripe and is flushed as such to a different page stripe in the memory than the page stripe where the data was previously stored; an entire page stripe is the targeted lowest unit of flushing. As discussed in detail below, as updated data is appended to an incomplete buffered page stripe, old redundancy data in the memory remains intact until the page stripe in which it resides is collected as a garbage collection unit (“GCU”).

User data stored in the memory 118 is updated from time to time as a result of host write commands, or “host writes.” In previous related art solutions, when a host write updates user data, that in turn requires updating the parity data corresponding to the updated user data as well. Thus, in those solutions at least two memory writes are necessary to perform a single host write. The present embodiments advantageously reduce the ratio of memory writes to host writes to well below two.

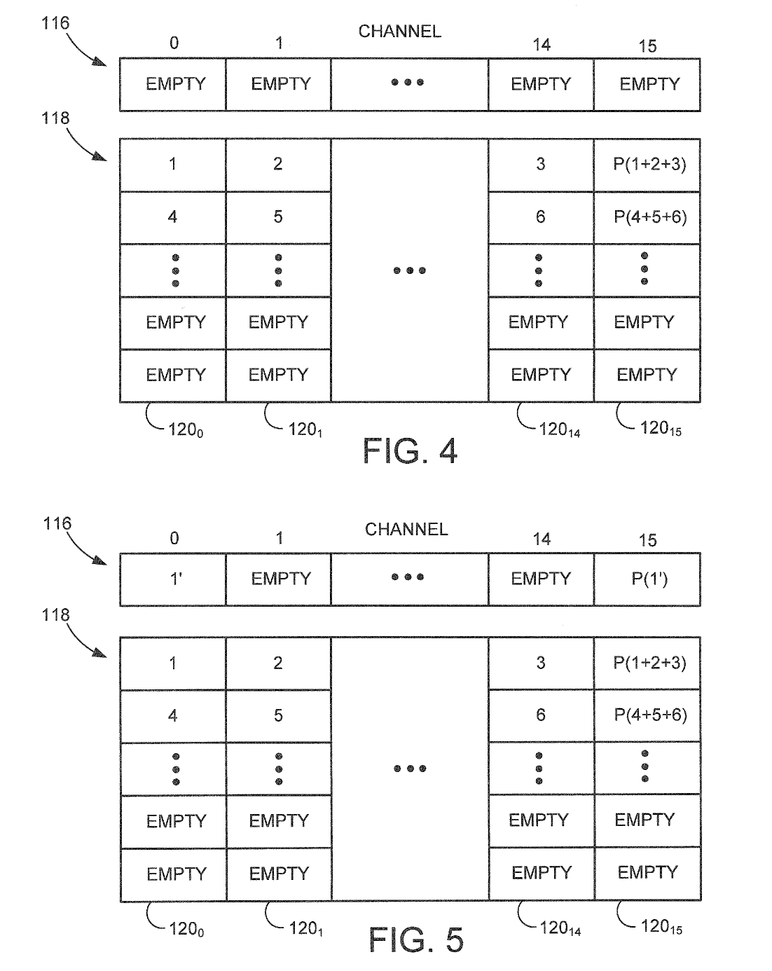

FIG. 4 depicts the tabular layout of one block of data in each of the sixteen channels of memory 118 referenced above as illustrative of the present embodiments. The numbers 1, 2, 3 . . . represent user data stored in the memory 118; for example, user data 1 is presently stored in channel 0. Writeback logic (“WL”) 140 (FIG. 1) resides in the controller 106, being executable to align a node of the buffer 116 with each of the channels 120 in the memory 118. The description that follows describes incrementally calculating parity for the buffered user data as it accumulates. The incremental parity calculations described below are merely illustrative and not necessarily a requirement of the present embodiments. Alternatively, parity can be calculated for the entirety of the buffered user data after it has been completely accumulated and before it is flushed.

FIG. 5 is similar to FIG. 4 but depicts the beginning of a new buffered page stripe of user data in response to a host write activity to update user data 1 to 1′. The writeback logic 140 appends to channel 0, without yet storing via channel 0, the updated user data 1′. For purposes of this description and meaning of the claims, “appends” means that a correspondence is established such that data appended to a particular channel will eventually be stored via that channel to which it is appended when it is flushed to the memory 118. “Appended” specifically does not mean that the appended data is necessarily stored via the channel to which it is appended prior to it being flushed to memory 118.

The writeback logic 140 also appends to channel 15, without yet storing via channel 15, redundancy data corresponding only to the updated user data 1′. Although for illustrative purposes the redundancy data is depicted as being parity data, the present embodiments are not so limited. For example, in alternative equivalent embodiments the redundancy data can exist as a mirrored arrangement of the buffered data or can be systematic error correction code, and the like. Note that the writeback logic does not at this time alter the previous redundancy data P(1+2+3) corresponding to the old user data 1 stored in memory 118.

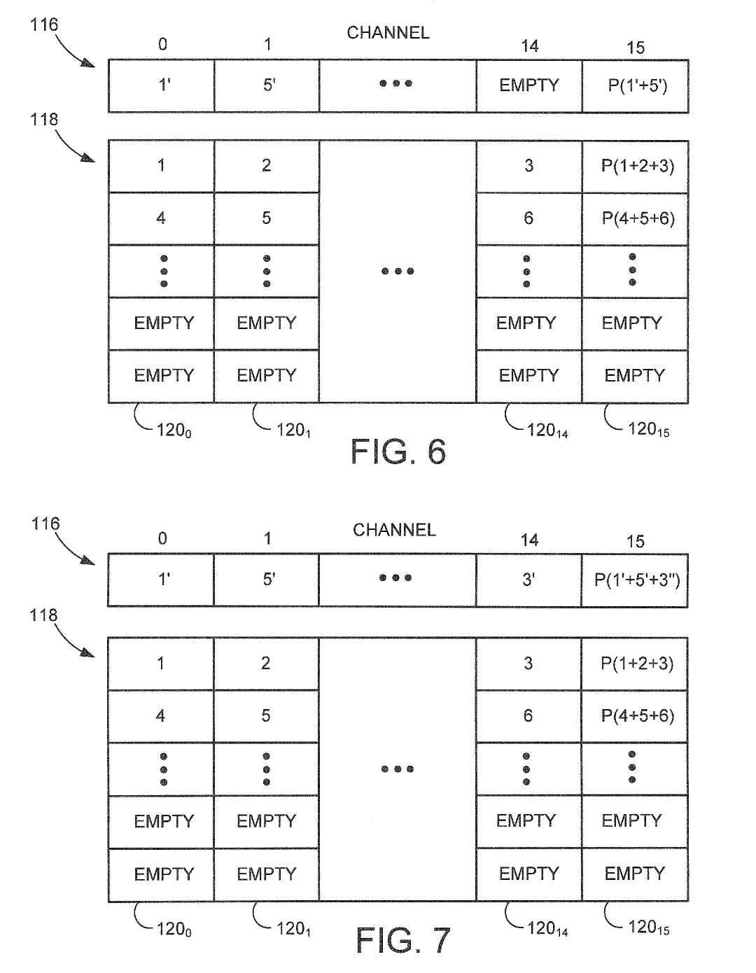

FIG. 6 similarly depicts the result of subsequent operations whereby a buffered page stripe continues to accumulate by the writeback logic 140 appending to channel 1, without yet storing via channel 1, updated user data 5′ in response to host write activity. The writeback logic 140 also calculates and appends to channel 15, without yet storing via channel 15, updated redundancy data P(1′+5′). As before, the writeback logic 140 does not alter the redundancy data P(4+5+6) stored in the memory 118 and corresponding to the old state of the user data 5.

FIG. 7 similarly depicts the eventuality whereby the buffered page stripe is completely accumulated by the writeback logic 140 appending to channel 14, without yet storing via channel 14, updated user data 3′ in response to host write activity. Again, the writeback logic 140 calculates and appends to channel 15, without yet storing via channel 15, updated redundancy data P(1′+5′+3′). Also as before, the writeback logic does not alter the redundancy data P(1+2+3) stored in the memory 118 and corresponding to the old state of the user data 3.

The accumulation of appended updated data and corresponding parity data is then flushed as a unit to a page stripe across the sixteen channels of the memory 118. In this illustrative example, that requires sixteen memory writes to the memory 118 to process the fifteen host writes for which the data was buffered in channels 0-15. That results in a host write to memory write ratio of 16:15, or 1.066, which is a significant reduction in write activity in comparison to the 2:1 ratio required by the related art solutions discussed above.

Now for these illustrative embodiments the greatest conservation of memory writes to host writes is achieved by flushing an entire page stripe of appended updated data and redundancy data at the same time. However, the skilled artisan readily recognizes that under certain circumstances it can be advantageous for the writeback logic 140 to temporarily flush less than a full complement of pages at the same time. During heavy host write activity, for example, the writeback logic 140 can adapt in an effort to prevent cache saturation by flushing either after updated data is presented for appending an entire page stripe or when a predetermined time interval expires, whichever occurs first. The fact that no updated data is presented for only one or a few of the channels might otherwise choke the write throughput to an unacceptable performance.

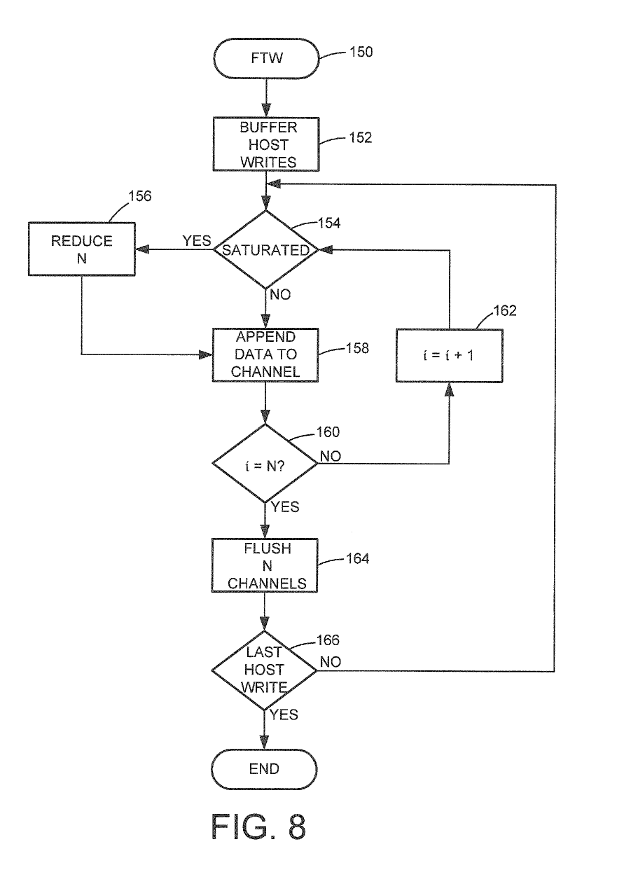

FIG. 8 depicts steps of a method 150 of fault tolerant writing (“FTW”) performed by the writeback logic 140 by executing programming instructions stored in memory 112, 114 to process host writes in a manner that maximizes the useful life of the memory 118 by conserving memory writes to host writes. The method begins in block 152 by buffering pending host writes, such as but not limited to by writeback caching them. Block 154 determines whether the buffer is presently operating at a threshold capacity associated with the risk that saturation will occur. If the determination of block 154 is yes, then in block 156 the predefined value of the number of pages in an entire page stripe, N, is reduced to effect flushing of less than an entire page stripe.

Control then passes to block 158 where updated data is appended to channel “i” of the memory 118. As discussed above, this entails associating the updated data to a memory channel without storing the updated data via the channel, and likewise calculating redundancy data to include the newly updated data without storing the redundancy data to the memory. Note also as discussed above that the appending step does not alter the redundancy data stored in memory and corresponding to the user data for which the updated data is now appended.

Block 160 then determines whether the number of channels having updated data appended thereto is equal to N. If no, then the counter “i” is incremented in block 162 and control returns to block 154. Otherwise, if the determination of block 160 is yes, then in block 164 the N pages of appended data are concurrently flushed to the memory, resulting in a favorable memory write to host write ratio of N:N−1. Block 166 determines whether the write buffer is empty or below a threshold capacity. If no, control returns to block 254; otherwise, the method ends.

Generally, the present embodiments have been described in terms of a data storage device that includes a multiple channel solid state memory, and means for updating user data previously stored in the memory according to subsequent host writes by grouping a plurality of memory writes and corresponding parity data and then storing to the memory by groups at a time so that the ratio of memory writes to host writes is less than two. For purposes of this description and meaning of the claims, “means for updating” has a meaning that encompasses the disclosed structure and equivalents thereof that append a plurality of the updated data to the respective channels of the memory without storing the updated data to the memory, calculates and likewise appends redundancy data for the plurality of appended updated data, then concurrently flushes the appended updated data and redundancy data to the memory. As disclosed, this advantageously reduces the ratio of memory writes to host writes to below a 2:1 ratio. The meaning of “means for updating” expressly does not include previously attempted solutions that require a memory writes to host writes ratio of two or more.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts and values for the described variables, within the principles of the present embodiments to the full extent indicated by the broad general meaning of the terms in which the appended claims are expressed.

What is claimed:

1. A data storage apparatus, comprising:
a memory having a plurality of storage elements defining an associated set of stored data; and
memory control logic that, responsive to a request to store first data in a first storage element of the plurality of storage elements, computes without storing to any of the plurality of storage elements first redundancy data for the associated set of stored data inclusive of the first data.

2. The data storage apparatus of claim 1 wherein the memory control logic by computing the first redundancy data does not alter other redundancy data stored in one of the plurality of storage elements and for the associated set of stored data non-inclusive of the first data.

3. The data storage apparatus of claim 1 wherein the memory control logic, responsive to a request to store second data in a second storage element of the plurality of storage elements, computes without storing to any of the plurality of storage elements second redundancy data for the associated set of stored data inclusive of the first data and the second data, and subsequently concurrently stores the first data and the second data and the second redundancy data to the memory.

4. The data storage apparatus of claim 1 wherein the memory control logic, responsive to a request to store a data stripe across the plurality of storage elements, computes without storing to any of the plurality of storage elements second redundancy data for the associated set of stored data inclusive of the data stripe, and subsequently concurrently stores the data stripe and the second redundancy data to the memory.

5. The data storage apparatus of claim 1 comprising a buffer to which the first data and the first redundancy data are stored before concurrently being flushed from the buffer to the memory.

6. The data storage apparatus of claim 3 comprising a buffer to which the first data and the second data and the second redundancy data are stored before concurrently being flushed from the buffer to the memory.

7. The data storage apparatus of claim 6 wherein the buffer comprises a nonvolatile memory.

8. The data storage apparatus of claim 1 wherein the first data comprises writeback data.

9. The data storage apparatus of claim 4 wherein the memory is characterized as a multiple channel solid state storage device.

10. The data storage apparatus of claim 9 wherein the memory stores data via one of at least fifteen channels.

11. The data storage apparatus of claim 1 wherein the request to store first data is received as a host command via a communication link between the host and the data storage apparatus, the memory control logic computing the first redundancy data entirely under a top level control of the data storage apparatus with no input from the host or any other device via the communication link.

12. The data storage apparatus of claim 11 wherein the communication link comprises a network.

13. A method comprising:
receiving a host command by a data storage device corresponding to storing data in a first storage element of a memory having a plurality of storage elements defining an associated set of stored data;
in response to the receiving step, computing without storing to any of the plurality of storage elements first redundancy data for the associated set of stored data inclusive of the first data.

14. The method of claim 13 wherein the computing step is characterized by not altering other redundancy data stored in one of the plurality of storage elements and for the associated set of stored data non-inclusive of the first data.

15. The method of claim 13 wherein the receiving step is characterized by receiving a host command corresponding to storing data in a second storage element of the plurality of storage elements, the method further comprising
in response to the receiving step, computing without storing to any of the plurality of storage elements second redundancy data for the associated set of stored data inclusive of the first data and the second data; and
after the computing steps, concurrently storing the first data and the second data and the second redundancy data to the memory.

16. The method of claim 13 wherein the receiving step is characterized by receiving a host command corresponding to storing a data stripe across the plurality of storage elements, the method further comprising:
in response to the receiving step, computing without storing to any of the plurality of storage elements second redundancy data for the associated set of stored data inclusive of the data stripe; and
after the computing steps, concurrently storing the data stripe and the second redundancy data to the memory.

17. The method of claim 16 wherein the second redundancy data is characterized as parity data.

18. The method of claim 16 wherein before the storing step, the computing steps are characterized by buffering the data stripe and the second redundancy data in a nonvolatile memory.

19. The method of claim 16 wherein the receiving step is characterized by the host command being received via a host communication link, and the computing steps being entirely self executed by the data storage device in response to the host command with no other input from the host or any other device via the host communication link.

20. A data storage apparatus, comprising:
a solid state memory (SSM) that stores a first data via a first channel to be part of an associated set of stored data; and
writeback logic appending to the first channel, without storing to the SSM, first updated data corresponding to an update of the first data, and appending to a different channel, without storing to the SSM, first redundancy data for the associated set of stored data inclusive of the first updated data.
